(19) United States
(12) Patent Application Publication
(10) Pub. No.: US 2025/0044105 A1
(43) Pub. Date: Feb. 6, 2025

(54) Method and Device for Detecting a Problem When Determining a Travel Path

(71) Applicant: Bayerische Motoren Werke Aktiengesellschaft, Muenchen (DE)

(72) Inventors: Florian JARMER, Muenchen (DE); Martin LIEBNER, Muenchen (DE); David PANNEN, Muenchen (DE)

(21) Appl. No.: 18/837,095

(22) PCT Filed: Jan. 11, 2023
(86) PCT No.: PCT/EP2023/050506

§ 371 Date: Aug. 8, 2024

(30) Foreign Application Priority Data
Feb. 18, 2022 (DE) 10 2022 103 856.4

(51) Int. Cl. G01C 21/28

(52) U.S. Cl. CPC G01C 21/28

(57) ABSTRACT

A device detects a problem with a determined travel path of a vehicle on a section of road. The travel path is determined by executing an optimization method for optimizing an error function that depends on sensor data recorded when the vehicle was travelling on the section of road. The device determines a parameter value of at least one parameter relating to the execution of the optimization method; and, on the basis of the determined parameter value, whether or not there is a problem when determining the travel path.

### CROSS REFERENCE TO RELATED APPLICATION

This application is a 371 of International Application No. PCT/EP2023/050506, filed Jan. 11, 2023, which claims priority under 35 U.S.C. § 119 from German Patent Application No. DE 10 2022 103 856.4, filed Feb. 18, 2022, the entire disclosure of which is herein expressly incorporated by reference.

### BACKGROUND AND SUMMARY

The present disclosure relates to a method and a corresponding device for detecting a problem when determining a travel path, in particular for detecting an erroneously determined travel path.

The sensor data captured by one or more vehicles and relating to the environment and/or the travel trajectory of the respective vehicle during a journey on a road section can be used to determine a travel path, for example a lane, on the road section. The determined travel path can then be included in map data for the road section. It is therefore possible to efficiently determine precise map data which indicate, for example, individual lanes for a road section. A SLAM (Simultaneous Localization and Mapping) method, in particular a graph SLAM method, can be used to determine a travel path on the basis of the sensor data from one or more vehicles.

The sensor data provided by the one or more vehicles may possibly be distorted. This may be the case, in particular, for GNSS measured values from a satellite-based navigation system (for instance for GPS measured values), for example if the road section passes through a tunnel. Distorted sensor data may result in erroneously determined travel paths and therefore in an impairment of the map data.

The present disclosure relates generally to the technical object of efficiently and reliably detecting a problem when determining a travel path, in particular an erroneously determined travel path, in particular in order to increase the quality of map data and the quality of automated driving functions based thereon.

The object is achieved by means of at least each of the independent claims. Advantageous embodiments are described, inter alia, in the dependent claims. It is pointed out that additional features of a patent claim dependent on an independent patent claim can form, without the features of the independent patent claim or only in combination with a subset of the features of the independent patent claim, a separate invention that is independent of the combination of all features of the independent patent claim and can be made into the subject matter of an independent patent claim, a divisional application or a subsequent application. This applies in the same manner to technical teachings which are described in the description and can form an invention independent of the features of the independent patent claims.

At least one aspect describes a device for detecting a problem when determining a travel path of a vehicle on a road section. The travel path may correspond, for example, to a lane of the road section. The device may be arranged in the vehicle. Alternatively, the device may be part of a unit outside the vehicle (for example a server).

The travel path may have been determined by performing an optimization method for optimizing an error function. In this case, the error function may depend on sensor data from one or more sensors (for example a camera, a GNSS-based position sensor, a speed sensor, a steering sensor, a rotational speed sensor, etc.) of the vehicle which were captured during a journey of the vehicle on the road section.

The sensor data for the journey of the vehicle may comprise, for example, measured position values (for example GNSS measured values) relating to the position of the vehicle. The position of the vehicle may be specified within a particular coordinate system (for example within a world coordinate system). The positions indicated by the measured position values may be arranged along the trajectory traveled by the vehicle on the road section. In addition, the sensor data for the journey of the vehicle may comprise odometry measured values relating to the movement (for example the travel speed (in one, two or three dimensions) and/or the direction of movement and/or the rotation rates (around one, two or three different axes (perpendicular to one another))) of the vehicle during the journey along the trajectory on the road section. The optimization method may comprise a Simultaneous Localization and Mapping (SLAM) method, in particular a graph SLAM method.

The error function may depend on a graph having a multiplicity of nodes for describing the travel path. In this case, the different nodes may correspond to different points on the determined travel path. Nodes from the multiplicity of nodes may be connected to one another in pairs via an edge in each case. Node conditions for the individual nodes (which each indicate, for example, a target position of the respective node) can be determined on the basis of the sensor data (in particular on the basis of the measured position values). Furthermore, edge conditions for the individual edges (which each indicate, for example, a relative orientation and/or relative alignment and/or a direction and/or a length of the respective edge) can be determined on the basis of the sensor data (in particular on the basis of the odometry measured values).

A node may indicate the pose of the vehicle at a particular time during a journey. The pose may comprise the (three-dimensional) position of the vehicle and/or the (three-dimensional) orientation of the vehicle. A node condition may comprise a condition relating to the pose of the vehicle.

An edge between two nodes may describe how the pose at the first node is converted into the pose at the subsequent, second node. The edge may therefore indicate a relative and/or delta position (by means of which the position at the first node is converted into the position at the second node). The edge may also indicate a relative and/or delta orientation (by means of which the orientation at the first node is converted into the orientation at the second node). An edge condition may therefore comprise a condition relating to the delta orientation (that is to say relating to the change in the orientation) and/or relating to the delta position (that is to say relating to the change in the position).

The error function may comprise an edge error term which depends on the odometry measured values in the sensor data and/or on the edge conditions. Alternatively or additionally, the error function may comprise a node error term which depends on the measured position values in the sensor data and/or on the node conditions. In this case, the edge error term may have a multiplicity of edge errors for the corresponding multiplicity of edges. The node error term may also have a multiplicity of node errors for the corresponding multiplicity of nodes. The optimization method can be designed to determine (in particular position) the multiplicity of nodes in such a manner that the error function is reduced, in particular minimized. The determined nodes after achieving the convergence criterion of the optimization method can then describe the determined travel path.

The device is configured to determine a parameter value of at least one parameter relating to the performance of the optimization method. In this case, the at least one parameter may describe the performance of the optimization method and/or the error function of the optimization method, in particular the development of the error function while performing the optimization method.

The parameter relating to the performance of the optimization method may comprise, for example, the value of the error function (which is a mean square error, for example) after performing the optimization method. Alternatively or additionally, the parameter relating to the performance of the optimization method may comprise the number of iterations when performing the optimization method until the convergence criterion is achieved.

Alternatively or additionally, the parameter relating to the performance of the optimization method may depend on the edge error term of the error function. The edge error term may respectively comprise an edge error, in particular a square edge error, for the multiplicity of edges of the graph. The parameter relating to the performance of the optimization method may comprise the maximum value of the edge errors for the multiplicity of edges after performing the optimization method.

The device is also configured to determine, on the basis of the determined parameter value, whether or not there is a problem when determining the travel path. It is possible to determine in particular, on the basis of the determined parameter value, whether the travel path is correct or erroneous, in particular whether or not the travel path corresponds to the trajectory traveled by the vehicle on the road section.

A device is described that is designed to efficiently and reliably detect an erroneously determined travel path by analyzing the optimization method that is performed. The travel path may then be determined again, if necessary. Alternatively or additionally, it is possible for the erroneously determined travel path to not be included in map data for the road section. The quality of the map data can therefore be increased.

The device may be configured to compare the determined parameter with a threshold value for the parameter. In this case, the threshold value may have been experimentally determined in advance on the basis of a multiplicity of reference performances of the optimization method for the purpose of determining a corresponding multiplicity of reference travel paths. It is then possible to determine, in a particularly reliable manner on the basis of the comparison, whether or not there is a problem when determining the travel path.

When it is determined that there is a problem when determining the travel path, the device may be configured to determine the travel path again. The error function may be adapted, the optimization method may be adapted, the initialization of the optimization method may be adapted and/or at least some of the sensor data may be excluded for determining the travel path again. The quality of the determined travel path can therefore be increased.

The device may be configured, for example, to identify the node of the graph with the maximum value of the node error (relative to the other node errors). The one or more measured position values for the identified node can then be excluded when determining the travel path again in order to increase the quality of the travel path determined again. Alternatively or additionally, it is possible to identify all nodes for which the corresponding node error is greater than or equal to a particular error threshold value. The one or more measured position values for the one or more identified nodes can then be excluded when determining the travel path again in order to increase the quality of the travel path determined again.

The device may be configured to determine parameter values for a plurality of different parameters relating to the performance of the optimization method. It is then possible to determine, in a particularly reliable and precise manner, on the basis of the determined parameter values, the type of the problem when determining the travel path from a set of different problem types. In this case, the set of different problem types may comprise: the presence of erroneous measured values in the sensor data; and/or the presence of an erroneous association between measured values from the sensor data (which relate to a landmark in an environment of the vehicle) and nodes and/or edges of the optimization graph for determining the travel path; and/or the presence of erroneous and/or unsuitable and/or poor initialization of the optimization method.

The graph for describing the travel path may comprise one or more nodes for one or more corresponding landmarks in the environment of the vehicle. Exemplary landmarks are traffic signs, lane markings, traffic lights, etc. These nodes may be referred to as landmark nodes, for example, in order to differentiate them from the nodes for the vehicle pose, which can be referred to as vehicle nodes. The graph may have edges between a vehicle node and one or more landmark nodes in each case. Measured values relating to the relative positioning of a landmark with respect to the pose of the vehicle can be determined on the basis of the sensor data, in particular on the basis of image data from a camera. An edge condition for an edge between a vehicle node and a landmark node can be established on the basis of a measured value. In this case, a landmark identified on the basis of the sensor data should be associated with a particular landmark node (for a particular landmark) and therefore with a particular edge of the graph. This association may possibly be erroneous. Such an erroneous association can be detected in an efficient and reliable manner by way of the measures described in this document.

If the (absolute) position of a landmark is known (for example from map data), a node condition for a vehicle node of the graph can be created on the basis of the sensor data, for example on the basis of image data, relating to the landmark. In particular, a measured value relating to the relative positioning of the landmark with respect to the vehicle and therefore relating to the pose of the vehicle can be determined on the basis of the sensor data (since the position of the landmark is known). In this case, an association is made between a landmark identified on the basis of the sensor data and a landmark (known from the map data) whose position is known. This association may possibly be erroneous. Such an erroneous association can be detected in an efficient and reliable manner by way of the measures described in this document.

The device may be configured to respectively determine, for a sequence of successive performances of the optimization method, whether or not there is a problem when determining the respective travel path. In this case, a temporal development of the parameter value of the one or more parameters for the different performances can be analyzed. On the basis of this, the quality of the respectively used sensor data and/or the respectively used optimization method can then be monitored. The quality of the determined map data can therefore be increased further.

A further aspect describes a (road) motor vehicle (in particular an automobile or a truck or a bus or a motorcycle) which comprises the device described in this document.

A further aspect describes a unit outside the vehicle, in particular a server, which comprises the device described in this document.

A further aspect describes a method for detecting a problem when determining a travel path of a vehicle on a road section. The travel path was determined by performing an optimization method for optimizing an error function, wherein the error function depends on sensor data from one or more sensors of the vehicle which were captured during a journey of the vehicle on the road section. The method comprises determining a parameter value of at least one parameter relating to the performance of the optimization method, and determining, on the basis of the determined parameter value, whether or not there is a problem when determining the travel path.

A further aspect describes a software (SW) program. The SW program can be configured to be executed on a processor and to thereby carry out the method described in this document.

A further aspect describes a storage medium. The storage medium may comprise a SW program which is configured to be executed on a processor and to thereby carry out the method described in this document.

It should be noted that the methods, devices and systems described in this document can be used both on their own and in combination with other methods, devices and systems described in this document. Furthermore, any aspects of the methods, devices and systems described in this document can be combined with one another in various ways. In particular, the features of the claims can be combined with one another in various ways. Furthermore, features cited between parentheses should be understood as meaning optional features.

One or more exemplary embodiments are described in more detail below.

### BRIEF DESCRIPTION OF THE DRAWINGS

FIG. 1a shows an exemplary vehicle;

FIG. 1b shows an exemplary road section;

FIG. 1c shows an exemplary graph for localization and mapping;

FIG. 2a shows an exemplary distribution of the maximum edge errors;

FIG. 2b shows an exemplary distribution of the number of iterations; and

FIG. 3 shows a flowchart of an exemplary method for detecting an erroneous travel path.

### DETAILED DESCRIPTION OF THE DRAWINGS

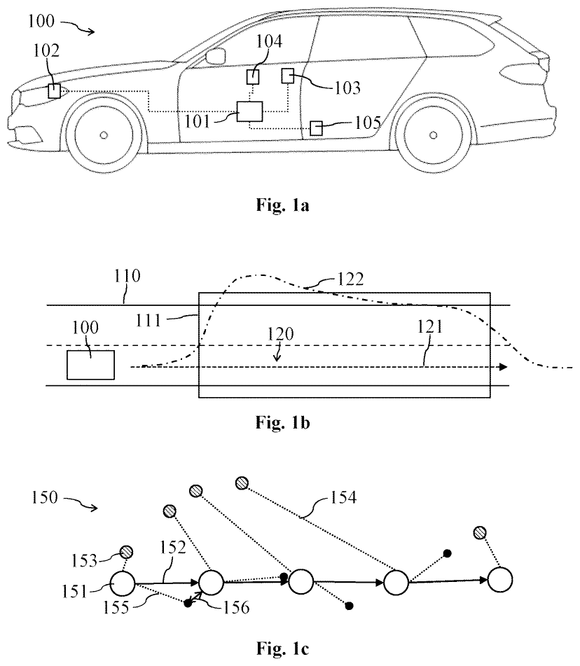

The embodiments described herein relate to efficiently and reliably detecting an erroneously determined travel path. In this context, FIG. 1a shows an exemplary vehicle 100 comprising one or more environmental sensors 102. Exemplary environmental sensors 102 are a camera, a radar sensor, a lidar sensor, an ultrasonic sensor, etc. The one or more environmental sensors 102 are configured to capture environmental data (that is to say sensor data) relating to the environment of the vehicle 100.

The vehicle 100 also comprises a position sensor 104 which is configured to determine position data (that is to say sensor data) relating to the position of the vehicle 100 in a world coordinate system using a global satellite-based navigation system (GNSS), for example GPS.

The vehicle 100 also comprises one or more vehicle sensors 103 which are configured to determine sensor data, for example the travel speed (in the longitudinal direction, in the transverse direction and/or in the vertical direction), the steering angle and/or the rotation rate (around the longitudinal axis, around the transverse axis and/or around the vertical axis), which enable odometry-based determination of the relative movement of the vehicle 100 over time (in particular between two successive times).

The vehicle 100 may also comprise an acceleration sensor 105 which is configured to determine measured values relating to a (three-dimensional) acceleration vector of the vehicle 100. The acceleration sensor 105 may comprise an inertial measurement unit (IMU), for example.

Sensor data may therefore be captured by a vehicle 100 during a journey along a road section, wherein the sensor data comprise, for example
measured position values from a GNSS sensor 104;
odometry measured values relating to the movement of the vehicle 100; and/or
camera images for identifying landmarks in the environment of the vehicle 100.

The sensor data may be captured for a sequence of measurement points along the road section. The sensor data may be provided, for example, by a unit outside the vehicle (for example a server). The unit outside the vehicle may be configured to determine a travel path for vehicles 100 on the road section on the basis of the sensor data for one or more journeys along the road section. The travel path may correspond, for example, to a lane on the road section. A SLAM algorithm can be used to determine the travel path.

FIG. 1b shows an exemplary road section 110 and a vehicle 100 which travels along a travel trajectory 120 in a lane of the road section 110. Sensor data can be captured along the travel trajectory 120 for a sequence of measurement points 121 and can be provided for the purpose of determining a travel path 122. As illustrated in FIG. 1b, the road section 110 may have a tunnel 111, for example, which results in the measured position values from the GNSS sensor 104 possibly being erroneous, at least for part of the travel trajectory 120. The erroneous measured position values may result in the determination of a travel path 122 with an erroneous course (which differs from the course of the travel trajectory 120) on the basis of the measured position values (for example using the SLAM algorithm), thus impairing the quality of the determined map data.

FIG. 1c shows an exemplary graph 150 comprising a multiplicity of nodes 151 which are partially connected to one another by means of edges 152. In this case, each node 151 may respectively indicate the pose, in particular the position, of a vehicle 100 on the travel path 122 to be determined. In particular, the nodes 151 may each correspond to a sampling point of the travel path 122 to be determined. The edges 152 may describe one or more edge conditions 155 relating to the transition between two nodes 151. The one or more edge conditions 155 may be determined on the basis of the sensor data provided for the one or more journeys (in particular on the basis of the odometry measured values).

Alternatively or additionally, one or more node conditions 153 for the individual nodes 151 may each be taken into account in the graph 150. In other words, the individual nodes 151 of the graph 150 may each have one or more node conditions 153 which relate (only) to the respective node 151 (in particular to the pose of a vehicle 100 at the respective node 151). The one or more node conditions 153 can be determined, in particular, on the basis of the sensor data provided for the one or more journeys (in particular on the basis of the measured position values).

The nodes 151 and the associated poses, in particular positions, of a vehicle 100 can be determined using an optimization method in such a manner that the conditions 153, 155 are satisfied as well as possible according to a particular error function (for example according to a least squares error function). In this context, a (square) node error 154 between the determined pose of the node 151 and the corresponding node condition 153 can be respectively taken into account, for example, for the individual nodes 151 or for the individual node conditions 153. Alternatively or additionally, a (square) edge error 156 between the determined edge 152 and the edge condition 155 can be respectively taken into account for the individual edges 152.

The error function can therefore depend on a multiplicity of (in particular the sum of) node errors 154 (for the corresponding multiplicity of nodes 151) and/or on a multiplicity of (in particular the sum of) edge errors 156 (for the corresponding multiplicity of edges 152). An (iterative) optimization method, for example a gradient descent method, can be used to orient, in particular position, the nodes 151 in such a manner that the error function is reduced, in particular minimized. The determined sequence of nodes 151 then describes the travel path 122 of the road section 110.

The specific performance of the optimization method for determining the travel path 122 can be described by one or more parameters. Exemplary parameters are
the number of iterations until a convergence criterion of the optimization method is achieved;
the value of the error function upon achieving the convergence criterion;
the value of the proportion of the error function based on the multiplicity of node errors 154; and/or
the value of the proportion of the error function based on the multiplicity of edge errors 156.

The parameter values of the parameters, which describe the specific performance of the optimization method, can be used to determine the quality of the travel path 122 determined by the specific performance of the optimization method. In particular, an erroneous travel path 122 can be detected on the basis of the parameter values of the parameters.

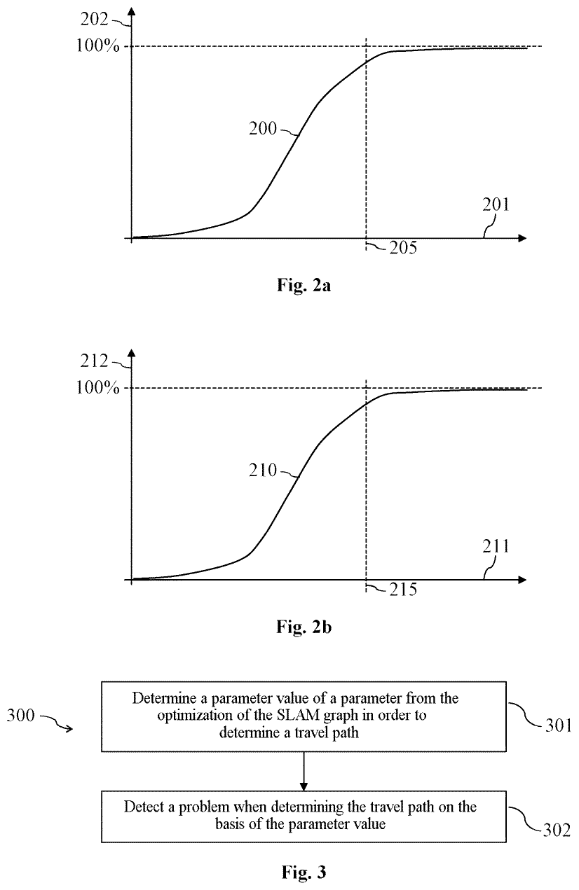

FIG. 2a shows an exemplary relationship 200 between the value 201 of the (mean) edge error 156 and the proportion 202 of the edge errors 156 which is less than or equal to a particular error value. An edge error threshold value 205 can be determined on the basis of this relationship 200. If the value 201 of the (mean or maximum) edge error 156 resulting from the performance of the optimization method is less than the edge error threshold value 205, this may be an indication that the determined travel path 122 is correct. If, on the other hand, the resulting value 201 of the (mean or maximum) edge error 156 is greater than the edge error threshold value 205, this may be an indication that the determined travel path 122 is erroneous.

FIG. 2b shows an exemplary relationship 210 between the number 211 of iterations of the optimization method and the proportion 212 of the performances of the optimization method that have converged in the case of the same number of or fewer iterations. An iteration threshold value 215 can be determined on the basis of the relationship 210. If the number 211 of iterations required during a specific performance of the optimization method is less than the iteration threshold value 215, this may be an indication that the determined travel path 122 is correct. If, on the other hand, the required number 211 of iterations is greater than the iteration threshold value 215, this may be an indication that the determined travel path 122 is erroneous.

In order to identify and, if necessary, correct an erroneously determined travel path 122, the graph optimization (for determining the travel path 122) may therefore be monitored. In this case, one or more metrics (or parameters), for example the maximum edge strain (that is to say the maximum edge error value), the mean square error, etc., which can be calculated from the optimization result, can be evaluated for the purpose of detecting erroneous input data, erroneous odometry or landmark measurements, etc. and/or detecting problems during optimization, during numerical convergence or when setting up the factor graph 150 (for example an erroneous association in the SLAM front-end). The automated detection and monitoring of optimization problems is therefore enabled, thus in turn increasing the robustness of the determination of travel paths 122.

For example, it is possible to detect erroneous results during the GPS odometry graph optimization for locating a vehicle 100. In this context, erroneous GPS measurements, as can occur for example at the start or end of a tunnel 111, may result, in particular, in the optimization failing and/or in the optimization result (and therefore the determined travel path 122) being distorted to a relatively great extent and therefore not corresponding to the actually traveled trajectory 120. The detection of this case of an error is advantageous, for example, in order to completely exclude erroneous travel paths 122 from the further processing.

The mean square error in the factor graph 150 after optimization can be used as a detection criterion and/or as an indication metric.

Alternatively or additionally, the maximum edge strain that occurs (for example a square error) can be used as a metric. This has the advantage that the detection is independent of the number of edges 152 (which is approximately proportional to the length of the trajectory 120). In the event of an error, the maximum edge strain that occurs cannot be compensated for by a relatively large number of edges 152 with a relatively small error in the case of relatively long trajectories 120.

Alternatively or additionally, the number of iterations of the numerical optimizer can be used as an indicator of the numerical convergence. In the case of a relatively high number of required iterations, the convergence criterion is not achieved or is achieved only at a relatively late stage, which indicates a relatively poorly conditioned optimization problem (for example on account of erroneous measurements and/or on account of erroneous assignments) and/or relatively poor convergence, for example on account of relatively poor variable initialization.

The respectively determined travel paths 122 can therefore be classified as erroneous or correct. The individual travel paths 122 can be classified in different error categories (that is to say problem types) using a combination of one or more metrics in order to distinguish, for example, between numerical convergence problems and erroneous input data or erroneous landmark associations in the SLAM front-end.

The optimization of a travel path 122 detected as erroneous can be repeated if necessary. In this case, the optimization problem can be modified before the new optimization in order to increase the probability of successful optimization. For this purpose, one or more GPS measurements detected as erroneous can be removed and/or one or more (possibly) erroneous data associations in the SLAM front-end can be removed and/or a different initialization of the variables or an adaptation of the optimization parameters (for example the number of maximum iterations, the damping factor during a Levenberg-Marquardt optimization, etc.) can be carried out.

The decision limit values or threshold values 205, 215 for the one or more metrics (that is to say parameters) can be determined in a data-driven manner on the basis of statistical distributions 200, 210 of optimizations that are actually performed.

Alternatively or additionally, the relative proportions of the data with certain errors can be continuously monitored in order to detect regressions in the data or previous algorithms. For example, a significant increase when using new data may indicate problems in the data. A significant increase when using identical data but when using a new version of the optimizer may indicate that there is a problem with the optimizer.

FIG. 3 shows a flowchart of an exemplary (possibly computer-implemented) method 300 for detecting a problem when determining a travel path 122 of a vehicle 100 on a road section 110, wherein the travel path 122 was determined by performing an optimization method for optimizing an error function (in particular by performing a SLAM method). In this case, the error function is dependent on sensor data from one or more sensors 102, 103, 104, 105 of the vehicle 100 which were captured during a journey of the vehicle 100 on the road section 110. The vehicle 100 may be driven, for example, along a particular travel trajectory 120, and the method 300 may be aimed at detecting whether or not the trajectory 120 traveled by the vehicle 100 is correctly described by the determined travel path 122.

The method 300 comprises determining 301 a parameter value of at least one parameter relating to the performance of the optimization method. The parameter may be designed to describe the performance of the optimization method (without describing the determined travel path 122 itself). The parameter may depend, for example, on the number 211 of iterations performed and/or on the value of the error function. The parameter can describe how well and/or how quickly the optimization method has converged to form the determined travel path 122.

The method 300 also comprises determining 302, on the basis of the determined parameter value, whether or not there is a problem when determining the travel path 122. At least one parameter which describes the performance of the optimization method can therefore be taken as a basis for detecting whether or not there is a problem when determining the travel path 122, in particular whether the determined travel path 122 is erroneous or correct.

The measures described in this document make it possible to efficiently and reliably detect erroneous sensor data, an erroneous establishment of the optimization problem and/or an erroneously determined travel path 122. The quality of map data and of an automated driving function based thereon can therefore be increased.

The present invention is not restricted to the exemplary embodiments shown. In particular, it should be noted that the description and the figures are only intended to illustrate, by way of example, the principle of the proposed methods, devices and systems.

1-12. (canceled)

13. A device for detecting a problem when determining a travel path of a vehicle on a road section, comprising:
one or more sensors configured to capture sensor data during a journey of the vehicle on a road section; and
a processor configured to determine the travel path by performing an optimization method for optimizing an error function that depends on sensor data,
wherein the processor is further configured to:
determine a parameter value of at least one parameter relating to the performance of the optimization method; and
determine, on the basis of the determined parameter value, whether or not there is a problem when determining the travel path.

14. The device of claim 13, wherein the processor is further is configured to determine, on the basis of the determined parameter value, whether the travel path corresponds to a trajectory traveled by the vehicle on the road section.

15. The device of claim 13, wherein the processor is further configured to:
compare the determined parameter with a threshold value for the parameter, wherein the threshold value is determined experimentally on the basis of a multiplicity of reference performances of the optimization method for the purpose of determining a corresponding multiplicity of reference travel paths; and
determine, on the basis of the comparison, whether there is a problem when determining the travel path.

16. The device of claim 13, wherein the processor is further configured to, when it is determined that there is a problem when determining the travel path:
determine the travel path again; and
adapt the error function, to adapt the optimization method and/or to exclude at least some of the sensor data for determining the travel path again.

17. The device of claim 13, wherein the parameter relating to the performance of the optimization method comprises a value of a mean square error function after performing the optimization method.

18. The device of claim 13, wherein the parameter relating to the performance of the optimization method comprises a number of iterations when performing the optimization method until a convergence criterion is achieved.

19. The device of claim 13,
wherein the error function depends on a graph having a multiplicity of nodes for describing the travel path,
wherein nodes from the multiplicity of nodes are connected to one another in pairs via an edge in each case,
wherein the error function comprises an edge error term which depends on odometry measured values in the sensor data, and
wherein the parameter relating to the performance of the optimization method depends on the edge error term.

20. The device of claim 19,
wherein the edge error term respectively comprises a square edge error for a multiplicity of edges of the graph, and
wherein the parameter relating to the performance of the optimization method comprises a maximum value of the edge errors for the multiplicity of edges after performing the optimization method.

21. The device of claim 13, wherein the processor is further configured to:
determine parameter values for a plurality of parameters relating to the performance of the optimization method, and
determine, on the basis of the determined parameter values, a type of the problem when determining the travel path from a set of different problem types,
wherein the set of different problem types comprises:
the presence of erroneous measured values in the sensor data,
the presence of an erroneous association between measured values from the sensor data, which relate to a landmark in an environment of the vehicle, and nodes and/or edges of an optimization graph for determining the travel path, and/or
the presence of erroneous and/or unsuitable initialization of the optimization method.

22. The device of claim 13, wherein the sensor data for the journey of the vehicle comprise:
measured position values relating to the position of the vehicle,
odometry measured values relating to a movement of the vehicle during the journey on the road section, and/or
the optimization method comprises a graph Simultaneous Localization and Mapping method.

23. The device of claim 13, wherein the processor is further configured to:
respectively determine, for a sequence of successive performances of the optimization method, whether or not there is a problem when determining the respective travel path, and
on the basis of the determination, monitor a quality of the respectively used sensor data and/or the respectively used optimization method.

24. A method for detecting a problem when determining a travel path of a vehicle on a road section, wherein the travel path is determined by performing an optimization method for optimizing an error function, wherein the error function depends on sensor data from one or more sensors of the vehicle captured during a journey of the vehicle on the road section, the method comprising:
determining a parameter value of at least one parameter relating to the performance of the optimization method; and
determining, on the basis of the determined parameter value, whether there is a problem when determining the travel path.
